(19) United States
(12) Patent Application Publication
(10) Pub. No.: US 2014/0037897 A1
(43) Pub. Date: Feb. 6, 2014

(54) CONFIGURABLE PROTECTIVE COVER, METHOD OF MAKING AND METHOD OF USING

(71) Applicant: G-Form, LLC, Providence, RI (US)

(72) Inventor: Daniel M. WYNER, North Scituate, RI (US)

(73) Assignee: G-Form, LLC, Providence, RI (US)

(21) Appl. No.: 14/052,330

(22) Filed: Oct. 11, 2013

Related U.S. Application Data
(63) Continuation of application No. 13/552,635, filed on Jul. 18, 2012, now abandoned.

(51) Int. Cl. A45C 11/00; B32B 3/26; B32B 3/10

(52) U.S. Cl. CPC A45C 11/00; B32B 3/10; B32B 3/266
USPC 428/138; 428/195.1

(57) ABSTRACT

Disclosed herein is a cover for an electronic device that comprises a plurality of medallions extending outwardly from a flexible base sheet. The base sheet is adapted to conform to at least a portion of the outer surface of the device, so that the medallions are located at impact regions such as the corners, edges and around the screen. The medallions are adapted to maintain the device in spaced relation from an impact surface.

### CROSS REFERENCE TO RELATED CASES

The present application is a continuation of co-pending and commonly owned U.S. patent application Ser. No. 13/552,635 filed on Jul. 18, 2012, which claims the benefit of U.S. Provisional Application No. 61/509,105, which was filed on Jul. 18, 2011, each of which is incorporated herein by reference in its entirety.

### TECHNICAL FIELD

The present invention relates generally to configurable covers designed to protect sensitive items from damage and/or to provide an exterior surface that is comfortable to touch.

### BACKGROUND

Protective cases for sensitive equipment, devices or instruments are often designed with padding on the interior or exterior, or both. Many times the padding is formed of continuous sheets of protective materials, such as neoprenes, foams and/or laminated materials, and the like. Such cases often do not offer sufficient protection from impact, vibration, and the like. Protection for the devices may be improved by using thicker materials, but increasing the thickness may not be desirable due to the added bulk or weight. Moreover, increased weight and bulk may be undesirable for streamlined electronic devices, for which users usually pay a premium in order to obtain slim and/or lightweight products.

Many electronic devices have a screen interface used to display information to users, so it is necessary to expose the screen during use. However, screen interfaces are known to be delicate, tending to break easily when dropped or otherwise impacted.

Portable electronic devices, such as laptop computers, or medical equipment, also have screen interfaces, and to protect the screen interface, such devices often include a hinged protective cover that provides some protection from dropping or impact, when not in use. However, many cell phones, media devices, and tablet-style computers or netbooks do not include such covers. Therefore, a screen or edge impact can easily cause severe damage to the screen and/or device. In addition, some devices, such as iPad devices, are very thin and delicate, which exacerbates their ability to withstand an impact. As a result, many companies now manufacture covers, cases and shells that can be purchased separately from the device s, which tend to fall into a few different categories.

One type of case is a rigid plastic shell, which may include internal or external padding, such as rubber or silicone. These types of shells are made for specific device sizes and configurations. In addition, rigid shells, even with some soft added elements, may not protect well against a drop of the face or open screen

Another type of case is a soft “skin,” generally made of rubber, silicone or other thermoplastic elastomeric (“TPE”) material. Like rigid plastic shells, skins are made for specific device sizes and configurations, and therefore cannot be used for “next-generation” devices. Other disadvantages are that they are generally thin, and therefore provide only minor impact protection and mostly scratch protection. Once again they are not generally able to protect the device from a significant drop on the screen side

There is a need for an improved case for sensitive equipment, devices or instruments.

### SUMMARY

The present disclosure is directed to a cover for an electronic device, comprising a flexible base sheet having a thickness. The base sheet is adapted to stretch and conform to at least a portion of the outer surface of the device. The base sheet comprises a plurality of spaced apart medallions having a thickness greater than that of the base sheet. The plurality of medallions extend outwardly from the base sheet, to maintain the device in spaced relation from a surface. The medallions may be disposed on the device such that they correspond to impact points, such as corners, edges and/or around the screen regions.

### BRIEF DESCRIPTION OF THE DRAWINGS

Referring now to the Figures, the features and advantages of the present disclosure will be apparent from the following more particular description of exemplary embodiments, as illustrated in the accompanying drawings, in which like reference characters refer to the same parts throughout the different views. The drawings are not necessarily to scale, emphasis instead being placed upon illustrating the principles of the disclosure.

FIG. 1 is a perspective front view of a media device with an exemplary protective cover according to the present disclosure, disposed on the device;

FIG. 2 is a perspective back view of the media device shown in FIG. 1;

FIG. 3 is an exploded top view of the front portion of the cover and the device shown in FIG. 1;

FIG. 4 is a top view of the front portion of the cover and device of FIG. 1;

FIG. 5 is a perspective view of the front portion of the cover and device of FIG. 1, with the device shown in phantom underneath the cover;

FIG. 6 is a perspective view of the front portion of the cover and device of FIG. 1, with the device shown in phantom underneath the cover, showing the process of folding the cover tabs onto the back of the device;

FIG. 7 is a back view of the device in FIG. 1, showing the front portion of the cover fully assembled onto the device of FIG. 1, again with the device shown in phantom underneath the cover;

FIG. 8 is an exploded back view of the back portion of the cover and the device shown in FIG. 7, with the front cover fully assembled onto the device;

FIG. 9 is a cross-sectional view of the device shown in FIG. 6, through line 9-9;

FIG. 10 is a cross-sectional view through one embodiment of the bezel region of the front cover;

FIG. 11 is a cross-sectional view through an alternative embodiment of the bezel region of the front cover;

FIG. 12 is a cross-sectional view through an alternative embodiment of the bezel region of the front cover;

FIG. 13 is a cross-sectional view of one embodiment of the back cover;

FIG. 14 is a cross-sectional view through another embodiment of the back cover;

FIG. 15 perspective front view of a laptop computer with another exemplary protective cover according to the present disclosure, disposed on the device;

FIG. 16 is a bottom view of the media device of FIG. 15; and

FIG. 17 is a cross-sectional view of the device shown in FIG. 15, through line 17-17.

### DETAILED DESCRIPTION

The present disclosure is directed to “stick-on” covers that can be removably applied to electronic devices such as media devices, smart phones, netbooks, notebooks, iPads, iPhones, MacAir, laptop computers, television screens, gaming devices, and the like. While the present disclosure has been described for protective covers for electronic devices, the disclosure can also be applied to any type of protective covers. The covers of the present disclosure include those that cover the entire body of electronic device, or portions thereof. For ease of illustration, the term “cover” will be used interchangeably herein to mean a cover for only portions of the device, or for substantially the entire device. The present covers include several features that combine reduced weight, reduced bulk, and improved aesthetics, while providing improved protection for the device. The improved cases may be used for sensitive equipment, devices or instruments, are lightweight and provide improved impact protection, particularly for exposed screen or “in-use” devices. The present cases are not specific to one device size, but instead can accommodate a range of device sizes.

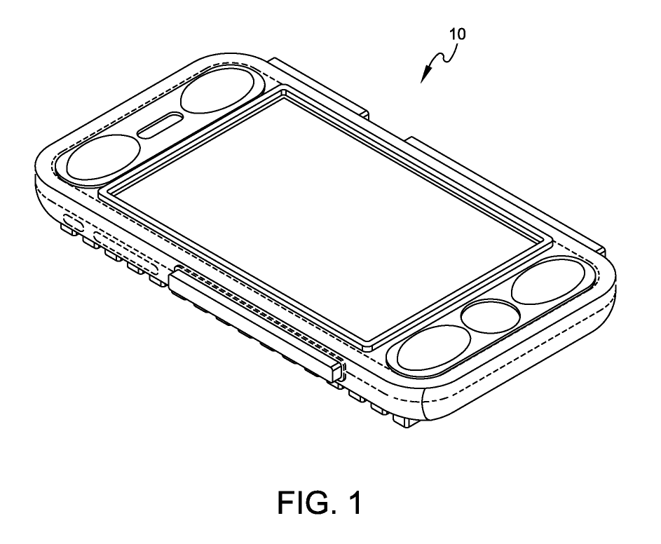

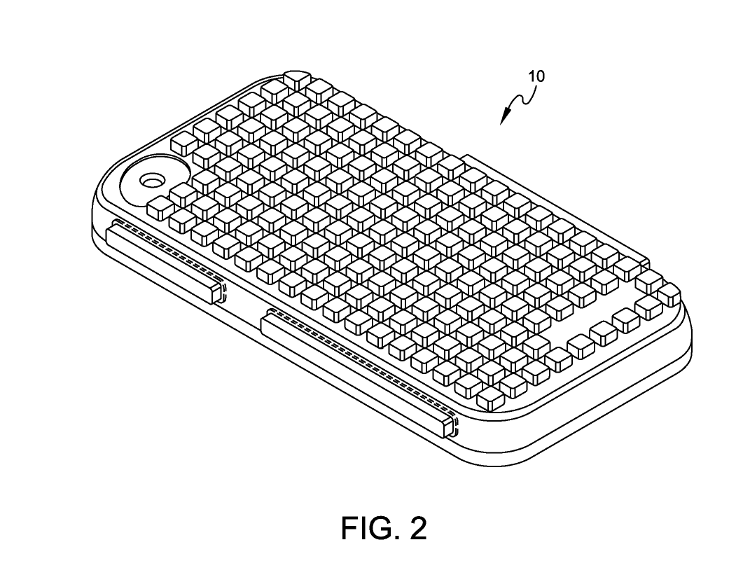

FIGS. 1-2 show front and back perspective views of a media device at least partially covered in an exemplary cover according to the present disclosure. The present cover comprises separable front and back covers 30,40.

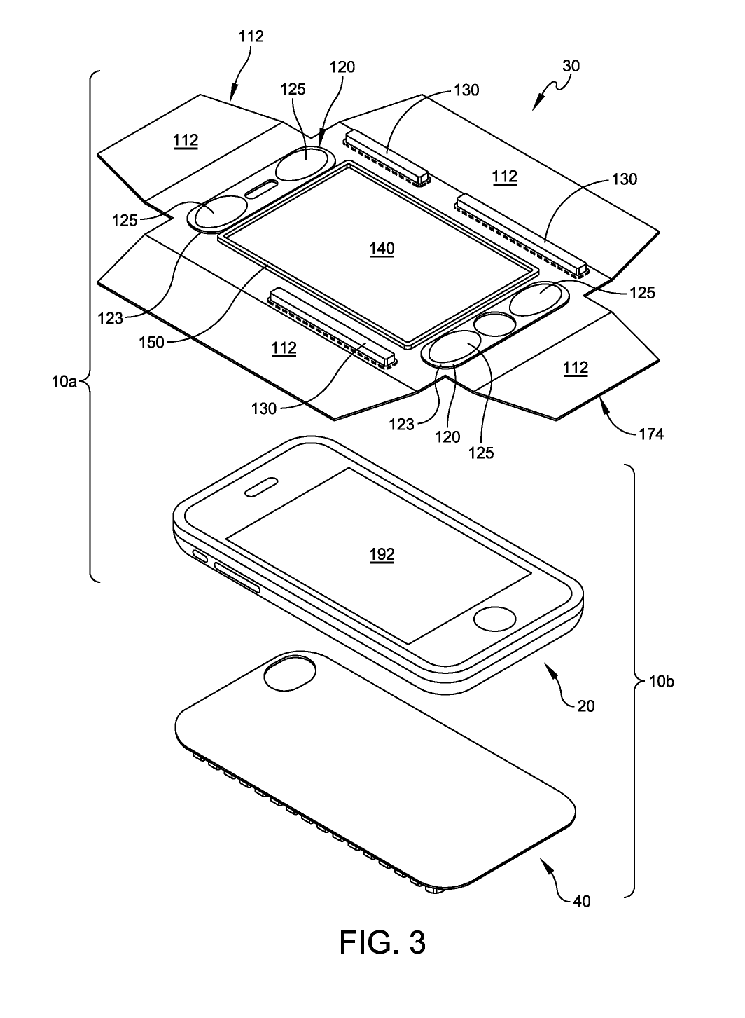

FIG. 3 shows an exploded view of the device 20, front cover 30 and back cover 40. As used herein, the assembly of the front cover 30 and device 20 is referred herein to as 10a, and the assembly of the back cover 40 and the device 20 is referred to herein as 10b.

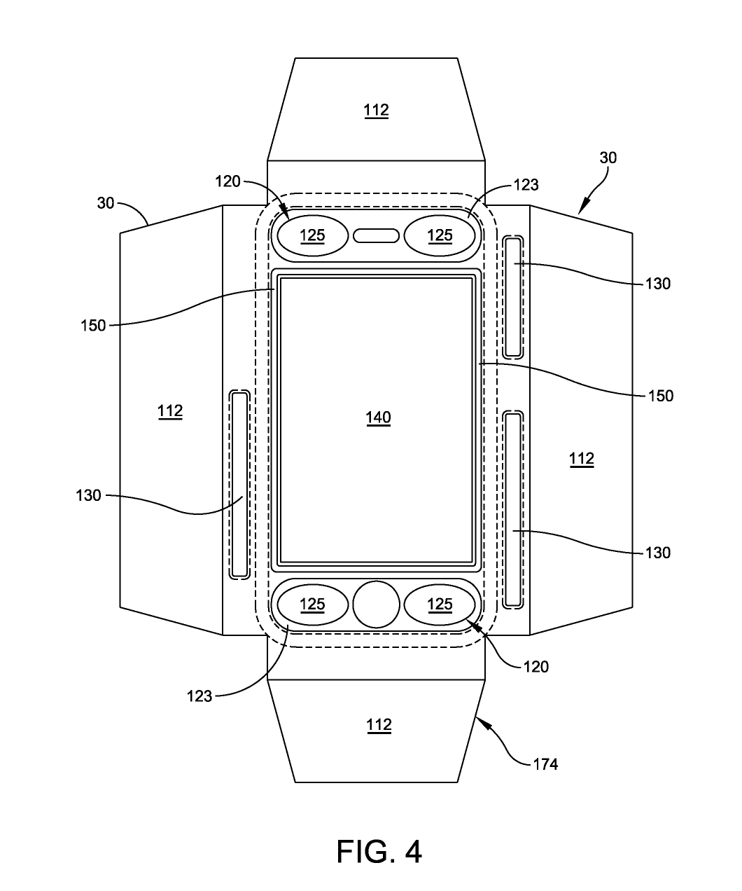

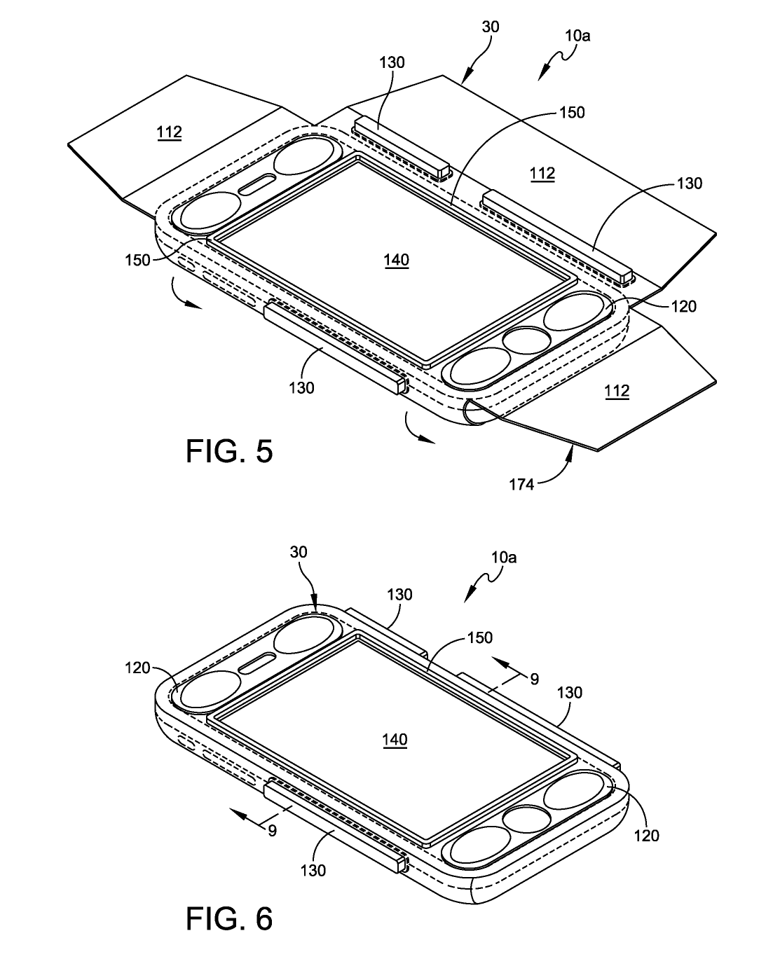

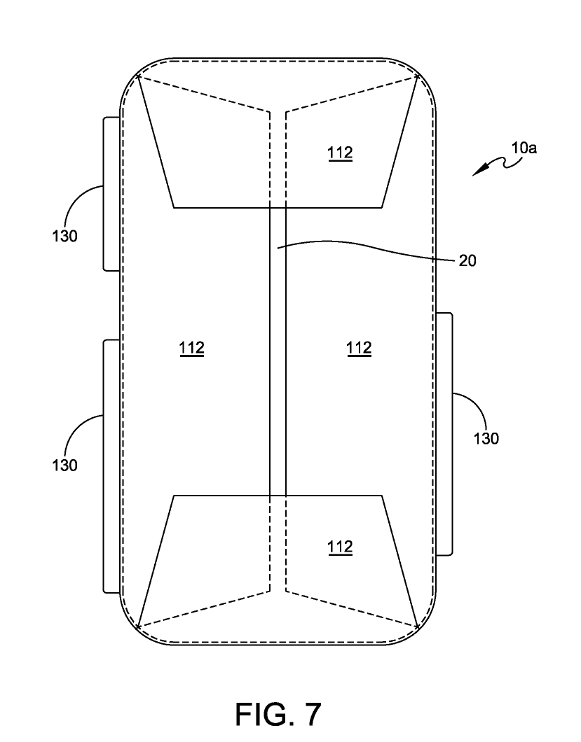

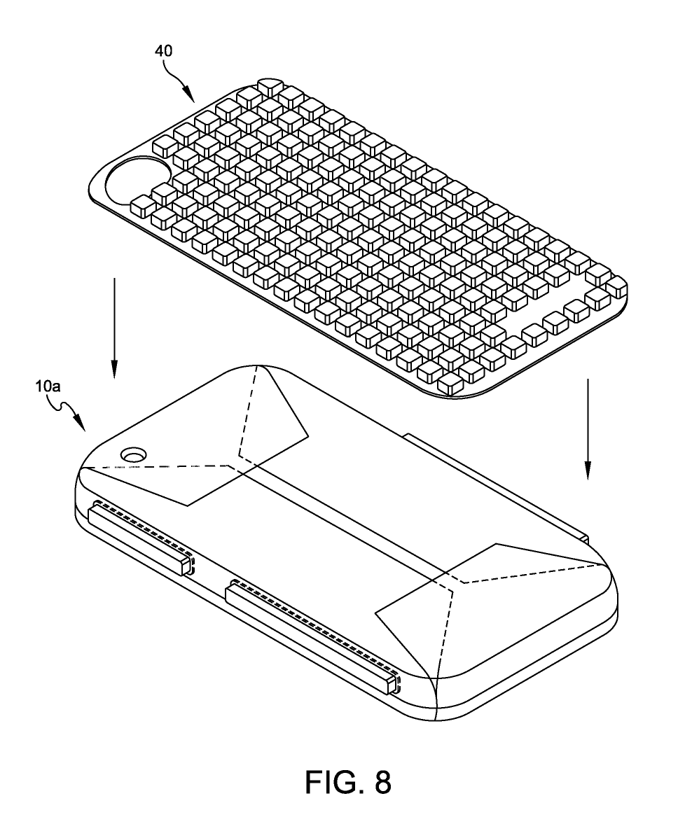

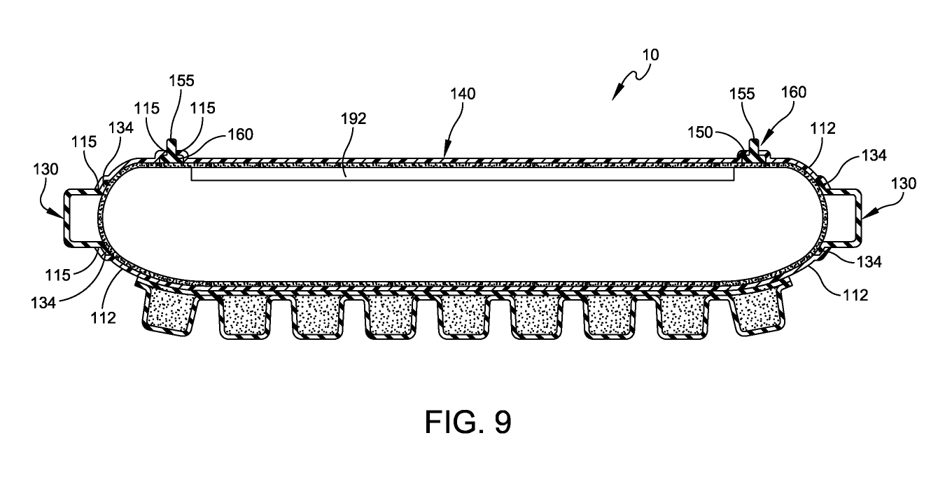

As shown in FIG. 4, front cover 30 comprises a base sheet 112 and a screen cover region 140 (hereinafter “screen cover”) sized and dimensioned to accommodate the front screen 192 of device 20. At least one impact-absorbing medallion 120 (“medallion”) is disposed adjacent to and between the base sheet 112 and the screen cover region 140, with an optional raised region 125 in the center, and an optional flange 123 extending outwardly from the raised region.

An optional bezel medallion 150 (hereinafter “bezel”) is disposed adjacent to and between the base sheet 112 and the screen cover region 140, with an optional raised region 155 in the center, and an optional flange 160 extending outwardly from the raised region.

At least one impact-absorbing side medallion 130 is disposed adjacent to the base sheet 112, with an optional raised region 133 in the center, and an optional flange 134 extending outwardly from the raised region.

Unlike other screen protectors, the present cover 30 extends beyond the screen 192 of the device, to cover function devices as well, and wraps around the device, folding onto the back side of the device. The relatively large surface area of the cover improves the adhesion of the smaller medallions, thereby minimizing or eliminating the tendency to peel away, were they not held down by the film.

The base sheet is adapted to conform to at least a portion of the outer surface of the device, so that the medallions are located at impact regions such as the corners, edges and around the screen. The medallions are adapted to maintain the device in spaced relation from an impact surface.

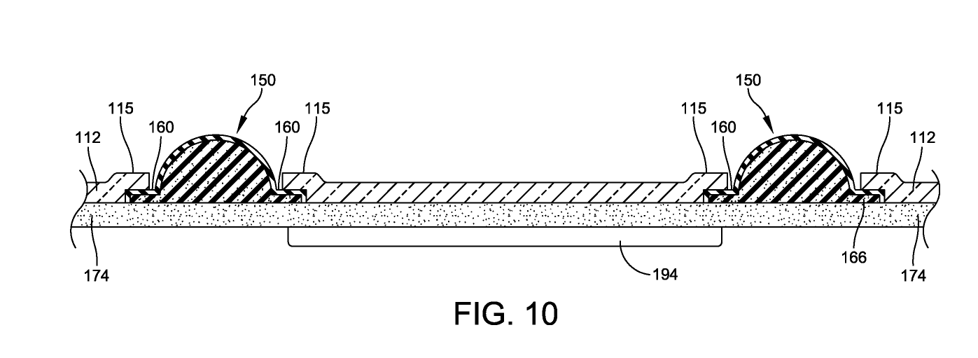

FIG. 10 shows base sheet 112 in cross-section, with an optional layer of a pressure sensitive adhesive (“PSA”) 174 disposed on the surface of the screen cover 140, facing the screen, and on the surface of base sheet 112, facing the body of the device. Optionally, the PSA may also be disposed underneath and adjacent to the medallions 120, 130. Suitable PSAs for the PSA disposed under the screen cover 140 are those that would be well known to manufacturers of non-impact protecting screen protecting films. Suitable PSAs for the PSA disposed on base sheet 112 include those that can bond to the body material, such as plastic, metal, and the like, and optionally that are permanently or temporarily repositionable, to allow a user to reposition the cover, or to remove the cover and apply it to a new device. Suitable PSAs for the optional PSA disposed underneath the medallion 120 include the same materials as those for the base sheet, provided that the PSA can also withstand any processing to which it may be subjected, such as the comolding described below. The first, second and third PSAs may be the same, provided that the PSA meets the requirements needed for the screen area. Those of skill in the art will recognize that other methods maybe used to attach medallions to the device, other than a PSA, such as magnetic attachment, a “clinging film” that adheres by cohesive force, Velcro, suction, static, and the like.

In the present embodiment, the optional raised region protrudes through an opening defined by base sheet 112 and screen cover 140 such that the sheet 112 and cover 140 overlap the flange 123 of the medallions 120, 130.

The thickness of the raised regions of the medallions and bezel can be selected to provide sufficient impact protection, without impeding the user's fingers. Also optionally, the thickness of the raised regions can be graduated such that the thickest portion is in the center of the medallion, and the thinnest portion is in the flange. Alternatively, the medallions can comprise a uniform thickness (i.e., no raised region) and when the raised region is omitted, the base sheet would overlap the edge of the medallion.

The medallions 120,130 may include optional openings corresponding to functional devices on the phone, such as the speaker and microphone, such that they are exposed for use, and the case does not interfere with the function of the device. As shown in the present embodiment, the cover comprises various openings that correspond to functional devices such as the device speaker, microphone, camera, and the like. Alternatively, the function devices may be protected by a film extending over the opening, formed from a material that does not interference with, for example, the speaker or the camera.

Suitable materials for base sheets include those that would be suitable for use as a screen protector for an electronic device such as a smart phone, such as a polyurethane film or sheet. If desired, the material used for the screen cover 40 can be different than the base sheet 112, and the material used in for the base sheet can be flexible or stretchy, to accommodate wrapping around the corners and/or sides of the devices.

A variety of techniques may be used to form the front cover. That is, the medallions 120, 130 and/or the bezel 150, and the base sheet 112 and cover 140 may be formed separately, and bonded, welded and/or glued together. Those of skill in the art will recognize that a variety of techniques and methods may be used to bond the medallions and sheet together including, but not limited to, chemical, mechanical, thermal bonds. Examples include bonding using an adhesive or cement, or sonic welding.

In the present embodiment, as shown in FIG. 10, the impact-absorbing medallions 120, 130 and base sheets 112, 140 are formed separately, and bonded together at interface region 115. Those of skill in the art will recognize that a variety of techniques and methods may be used to bond the medallions and sheet together including, but not limited to, chemical, mechanical, thermal bonds. Examples include bonding using an adhesive or cement, or sonic welding.

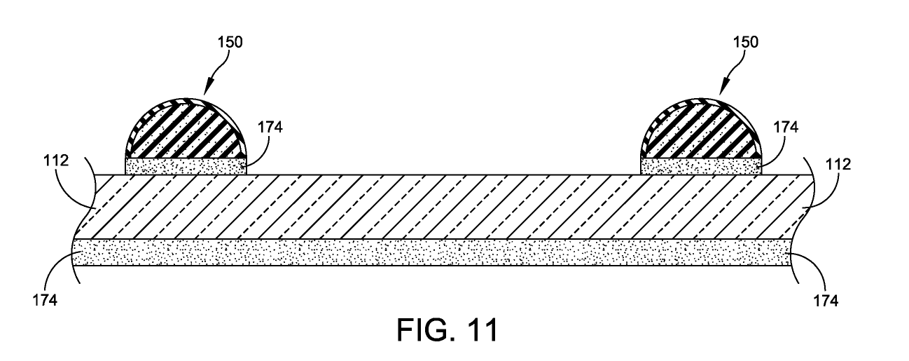

In an alternative embodiment, as shown in FIG. 11, the base sheet does not include an opening through which the medallions 120,130 and/or bezel 150 protrude and, instead, the medallions 120,130 and bezel 150 are disposed on the upper surface of the base sheet 112. As in the previous alternative embodiment, the medallions 120,130 and bezel 150 are formed separately from the base sheet 140, and bonded together at interface 115, using the same techniques mentioned above, and methods disclosed in the publications listed above. If desired or necessary, an intermediate layer, such as a PSA 174, may be disposed between the lower surface of the medallions 120,130 and/or bezel 150, to facilitate bonding therebetween.

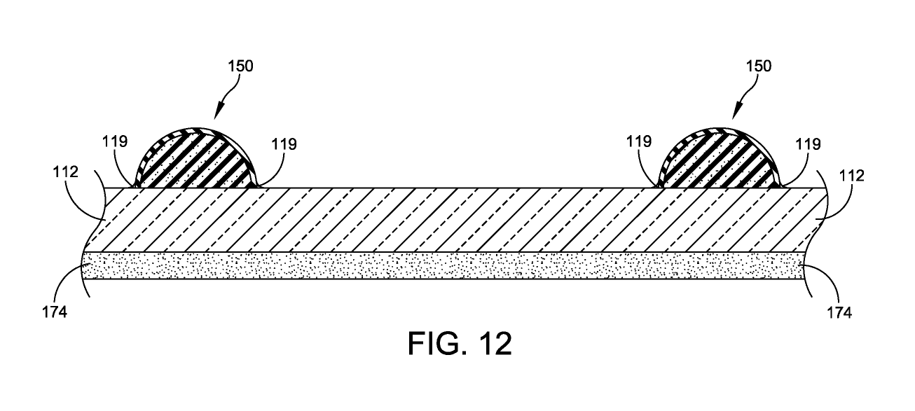

In another alternative embodiment, as shown in FIG. 12, the base sheet 112 does not overlap the medallions 120,130 and/or bezel 150. Instead, the base sheet 112 and medallions 120,130 and/or bezel 150 have a contiguous interface at region 119, such as may be produced when co-molded, using the same techniques mentioned above, and methods disclosed in the publications listed above.

Those of skill in the art will recognize that a variety of techniques and methods may be used to bond the medallions and sheet together including, but not limited to, chemical, mechanical, thermal bonds. Examples include bonding using an adhesive or cement, or sonic welding.

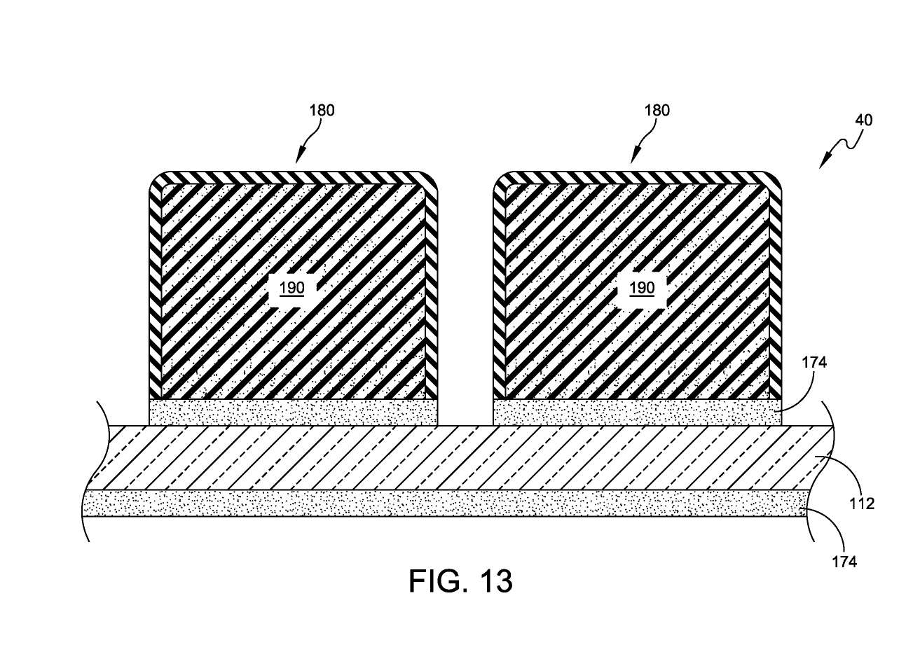

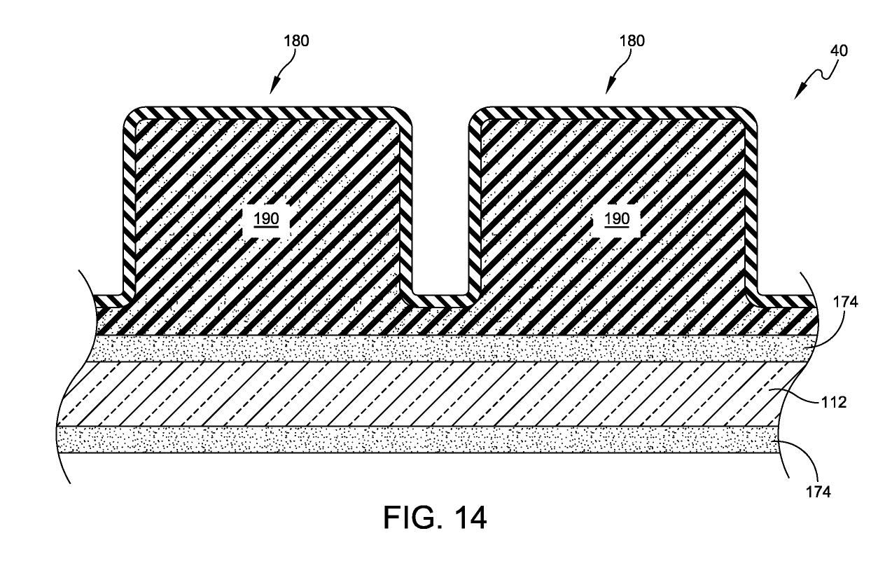

FIG. 13 shows a cross-section of the back cover 40, which comprises a plurality of spaced apart impact absorbing medallions 180 disposed on a base sheet 112, which may comprise the same material as the front cover base sheet. The back cover may comprise the same construction techniques as the front cover. That is, the medallions 180 and base sheet 112 may be formed separately, and bonded, welded and/or glued together.

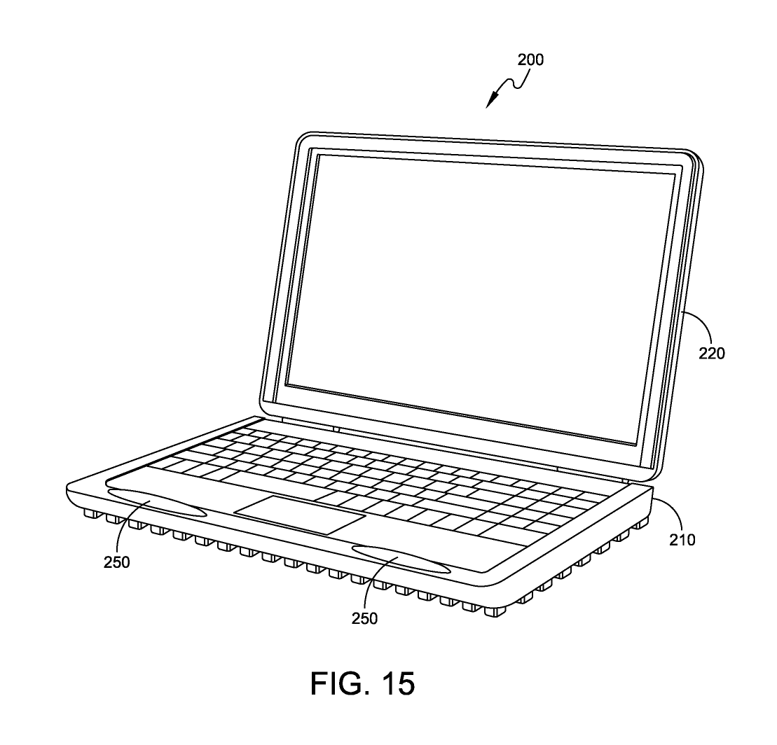

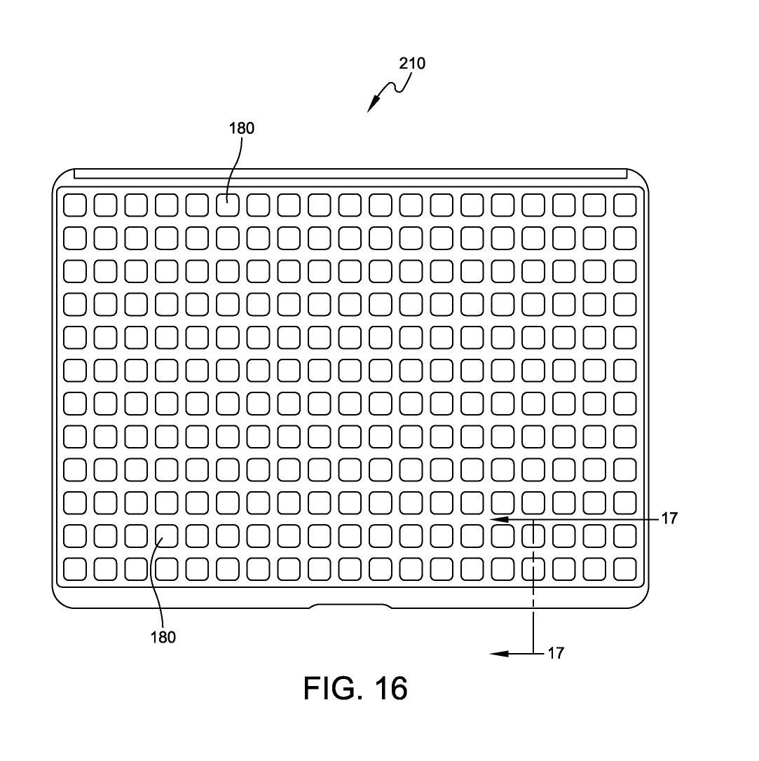

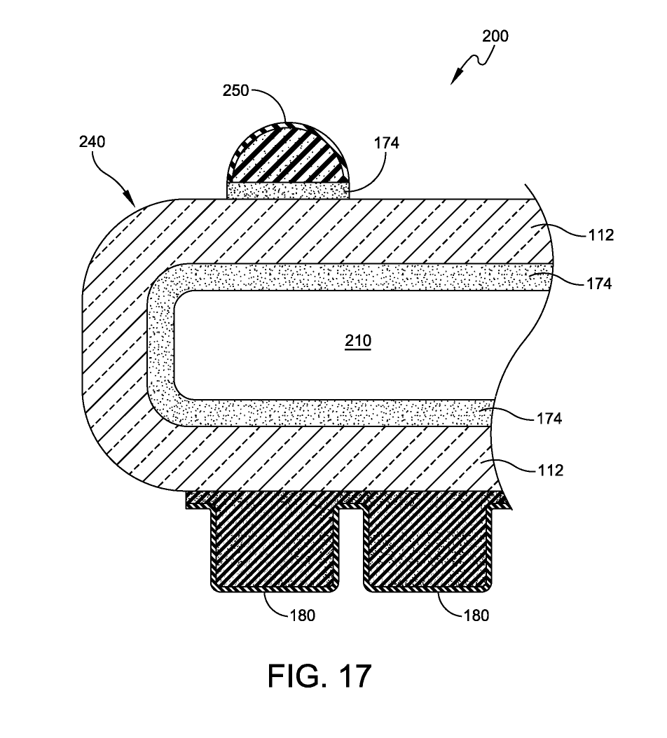

FIGS. 15-17 show a laptop device 200 with a base 210 and a hinged cover 220, with an exemplary cover 240 according to the present disclosure. The top surface of the base 210 comprises at least one medallion 250 disposed adjacent to the keyboard, which spaces the cover 220 from the base 210, and minimizes impact from closing, during a fall, and the like. The bottom surface of the base comprises a plurality of spaced apart medallions 180, similar to the back cover in the previous embodiment. The medallions 180 and 250 are supported on a base sheet 112, as in the previous embodiment, and may be constructed using the same materials and techniques as in the previous embodiment.

The medallions and bezels according to any of the embodiments herein may be formed from a variety of materials including, but not limited to, polymeric materials, including foamed polymeric materials, composite materials, and the like. One exemplary material is a rate dependent foam available from Rogers Corporation (Rogers, Conn.) under the product name PORON XRD®. Other suitable materials and methods of making the medallions and/or covers are disclosed in U.S. Publication Nos. 2007/0261274, 2008/003614, 2009/0255625, which are incorporated herein by reference in its entirety. In some embodiments, the materials from which the medallions are made may comprise a cushioning material 190 and an extensible outer layer 195, such as a TPE film.

The present covers are also flexible and conformable and, as a result, the covers can conform to contoured surfaces, such as the slightly curved surfaces of iPhones and iPads; to relatively sharp edges, such as the edges of iPad and MacAir devices; and can wrap around side edges, such as the sides of iPhone devices and many laptop computers. The present covers are also configurable, i.e., they can be configured for multiple devices, eliminating the need to manufacture device-specific covers.

All of the foregoing features reduce manufacturing time and costs, and provide accessory manufacturers with the ability to provide covers for “next generation” devices as they are brought to market, thereby eliminating the delay time that often occurs between the introduction of new devices and the introduction of accessories for devices. All of the foregoing also may reduce consumer costs, by eliminating the need to purchase a new cover when purchasing a “next generation” device, and improves customer satisfaction for “next generation” devices, because accessories, particularly protective accessories, are available at the same time.

Some embodiments comprise pre-assembled covers comprising medallions affixed to a film or an elastic fabric than can be stretched to conform to the shape of the device to be protected as well as embodiments in which the medallions are positioned and affixed to the device by the user. By combining specific shapes, sizes, configurations, contours and orientations of the medallions, the protective covers can be designed to protect specific, targeted areas of the device to be protected. The size, shape, thickness and composition of the medallions may be varied, depending on a number of factors including, but not limited to, the desired effect, e.g., impact resistance, vibration dampening, and the like. In addition, the configuration of the medallions may be varied, and more than one type of medallion shape may be used to provide protection for a specific device.

The size, shape, configuration, orientation and dimensions of the pad, medallions, medallion contours, hinges, grooves and flange may be varied as desired in order to achieve the desired characteristics for the medallion design. However, it should be understood that in each of the foregoing embodiments, and in any medallion according to the present disclosure, all of the foregoing measurements can vary depending on the desired characteristics and design of the medallion. For example, the medallion s are designed to provide a variety of characteristics such as, but not limited to, cushioning, vibration dampening and/or impact absorption, and the like. The characteristics of the medallion may be varied by changing the thickness and/or material type of cushioning layer in the medallions, changing the spacing between the medallions (e.g., the width of the channels), and/or changing the contours of the medallions, and the like. For example, using a gel for cushioning layer provides a pad with cushioning and vibration dampening characteristics; using a foam decreases the weight of the pad; using a frothed foam increases the impact absorption of the pad; etc. In general, increasing the thickness of the cushioning layer in the medallions generally increases the foregoing characteristics; and using a combination of materials for cushioning layer may provide a combination of characteristics.

It should be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. Similarly, it is noted that the terms “bottom” and “top” are used herein, unless otherwise noted, merely for convenience of description, and are not limited to any one position or spatial orientation. In addition, the modifier “about” used in connection with a quantity is inclusive of the stated value and has the meaning dictated by the context (e.g., includes the degree of error associated with measurement of the particular quantity). Unless defined otherwise, technical and scientific terms used herein have the same meaning as is commonly understood by one of skill in the art to which this disclosure belongs.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of any appended claims.

What is claimed is:

1. A cover for an electronic device, comprising:
a first, flexible base sheet adapted to stretch and conform to at least a portion of an outer surface of the device, the first base sheet comprising opposing left and right sides;
a first, bezel medallion extending outwardly from the first base sheet, the first bezel medallion comprising a cushioning material and having a thickness greater than that of the base sheet;
wherein, when the cover is assembled on the device, the left side overlaps at least a portion of the right side, and the bezel medallion corresponds to a screen of the device.

2. The cover of claim 1, further comprising at least a second medallion extending outwardly from the first base sheet, the second medallion a cushioning material, wherein, when the cover is assembled on the device, the second medallion corresponds to a side or edge of the device.

3. The cover of claim 1, wherein each of the medallions are connected to the base sheet by one of bonding, welding or an adhesive.

4. The cover of claim 1, wherein each of the medallions further comprises a inner flange and an outer flange.

5. The cover of claim 4, wherein the first sheet is connected to the medallions at the flanges.

6. The cover of claim 5, wherein the first sheet is connected to the flanges by one or more of bonding, welding or an adhesive.

7. The cover of claim 1, wherein the first sheet has an opening corresponding to the device screen.

8. The cover of claim 4, further comprising a transparent screen cover that is a different material than the base sheet, and wherein the transparent screen cover overlaps and is connected to the bezel medallion at the inner flange.

9. The cover of claim 1, wherein the cushioning material is a rate dependent foam material.

10. The cover of claim 1, further comprising a second, flexible base sheet having a thickness and being adapted to stretch and conform to at least a portion of the outer surface of the device, the second base sheet comprising a plurality of spaced apart medallions extending outwardly from the second base sheet and having a thickness greater than that of the second base sheet.

11. The cover of claim 10, wherein, when the cover is assembled on the device, the second sheet overlays at least a portion of the first sheet.

12. A cover for an electronic device, comprising:
a first, flexible base sheet adapted to stretch and conform to at least a portion of an outer surface of the device, the first base sheet comprising a first medallion extending outwardly therefrom, the first bezel medallion comprising a cushioning material having a thickness greater than that of the base sheet;
a second, flexible base sheet adapted to stretch and conform to at least a portion of the outer surface of the device, the second base sheet comprising a second medallion extending outwardly therefrom and having a thickness greater than that of the second base sheet;
wherein, when the cover is assembled on the device, the second sheet overlaps at least a portion of the first sheet.

13. The cover of claim 12, wherein each of the medallions are connected to the base sheet by one of bonding, welding or an adhesive.

14. The cover of claim 13, wherein each of the medallions further comprises a inner flange and an outer flange.

15. The cover of claim 14, wherein each of the medallions are connected to the sheets at the flanges.

16. The cover of claim 12, wherein one of the first and second sheets has an opening corresponding to a device screen.

17. The cover of claim 12, wherein the cushioning material is a rate dependent foam material.

18. The cover of claim 12, wherein the first and second sheets are unitary.

19. The cover of claim 12, wherein the first and second sheets are connected to the base sheet by one of bonding, welding or an adhesive.
